(19) United States
(12) Patent Application Publication
(10) Pub. No.: US 2023/0152427 A1
(43) Pub. Date: May 18, 2023

(54) LASER RADAR RECEIVING SYSTEM

(71) Applicant: HANGZHOU OLE-SYSTEMS CO., LTD, Hangzhou, Zhejiang (CN)

(72) Inventors: Ou Zhang, Hangzhou, Zhejiang (CN); Ding Ding, Hangzhou, Zhejiang (CN); Yaping Zhu, Hangzhou, Zhejiang (CN)

(21) Appl. No.: 17/916,511

(22) PCT Filed: Feb. 25, 2021
(86) PCT No.: PCT/CN2021/077818

§ 371 Date: Sep. 30, 2022

(30) Foreign Application Priority Data
Apr. 2, 2020 (CN) 202010255612.0
Apr. 2, 2020 (CN) 202020466969.9

(51) Int. Cl. G01S 7/481; G01S 17/08

(52) U.S. Cl. CPC G01S 7/4814; G01S 17/08

(57) ABSTRACT

A laser radar receiving system including a laser radar and a reflecting element. The laser radar includes a first reflector mirror, an emitting channel, an emission system and a basic receiving system. The laser beam emitted by the emission system is reflected by the first reflector mirror, reaches a target through the emitting channel, is reflected from the target and passes through the emitting channel, and is reflected by the first reflector mirror and received by the basic receiving system. The reflecting element is provided in an area outside the emitting channel that is unreachable by the laser beam reflected from the target, and is used for reflecting the laser beam from the area outside the emitting channel to the basic receiving system, thereby simultaneously avoiding blind area and stray light interference in short-range measurements, and improving measurement accuracy and expanding the short-range measurement range of radar.

### TECHNICAL FIELD

The present application relates a laser radar, in particular a receiving system of the laser radar.

### BACKGROUND

Laser radar is an active distance detection device using photoelectric detection technology, which is widely used in unmanned driving, unmanned aerial vehicles, robots and other fields.

At present, all laser radars basically have a range, including the longest range (upper limit) and the shortest range (lower limit). General laser radar has a near blind area. For example, the target within a certain distance from laser radar cannot be detected. There are many reasons for the existence of the near blind area. For example, when a parallel beam of light hits the rough surface of the target, the surface will reflect the light in all directions. Therefore, due to the inconsistency of the normal directions of each point, the parallel incident rays would be reflected randomly in different directions. Moreover, the existing laser radar is provided with an emitting channel. When the target is near the laser radar, part of the light reflected back from the diffuse reflection of the target is blocked by the transmitting channel, and this part of the light cannot be projected to the receiving tube, so it is difficult to guarantee the measurement range of the two-dimensional or three-dimensional information of the target. Therefore, the existing laser radar has a blind area for short-range detection.

How to further expand the short-range measurement range of the existing laser radar has been one of the key issues in the laser radar research field.

### DESCRIPTION OF THE INVENTION

In order to solve the problem in the prior art that the laser radar has a blind area for short-range detection due to the blocking of the emitting channel, resulting in the fact that the nearest measurement range of the laser radar is still not close enough, the present application relates a laser radar receiving system, in which the laser radar includes a first reflector mirror, an emitting channel, an emission system and a basic receiving system. The laser beam emitted by the emission system is reflected by the first reflector mirror, and then reaches the target through the emitting channel. The laser beam reflected from the target passes through the emitting channel, and then is reflected by the first reflector mirror and finally received by the basic receiving system, in which the laser radar receiving system further includes a reflecting element,

The space outside the emitting channel includes an area which the laser beam diffusely reflected from the target cannot reach due to the blocking of the emitting channel, and the reflecting element is disposed outside the area and used for reflecting the laser beam diffusely reflected from the target to the basic receiving system.

Further, the laser radar further includes a window cover, inside which the first reflector mirror, the transmitting channel and the reflecting element are arranged, and outside which the transmitting system and the basic receiving system are arranged. The space outside the transmitting channel inside the window cover includes a first area, a second area and a third area. The first area is an area which the laser beam diffusely reflected from the target cannot reach due to the blocking of the transmitting channel, the second area is the area which the laser beam emitted from the emitting channel is reflected back into the window cover through the window cover, the third area is located between the first area and the second area, and the reflecting element is disposed in the third area, and is used for reflecting the laser beam diffusely reflected from the target back into the third area to the basic receiving system.

Further, the spatial size of the first area is negatively correlated with the distance between the target and the laser radar.

Further, the reflecting element is a reflector mirror. The emitting channel has an opaque hollow cylindrical structure.

Further, the emission system includes a laser tube for emitting laser beams and a second reflector mirror, and the laser beams emitted by the laser tube are reflected by the second reflector mirror and the first reflector mirror in turn, and then pass through the emitting channel to the target conveyed outside the window cover. The basic receiving system includes a third reflector mirror and a receiving tube, and the laser beam diffusely reflected by the target passes through the transmitting channel, and then is reflected to the receiving tube by the first reflector mirror and the second reflector mirror in turn.

Further, the reflecting surface of the first reflector mirror and the reflecting surface of the reflecting element are opposite to and parallel to the reflecting surface of the third reflector mirror.

Further, the central axis of the transmitting channel intersects with the center of the first reflector mirror, the optical axis of the receiving tube intersects with the center of the third reflector mirror at an angle of 45°, the optical axis of the laser tube intersects with the center of the second reflector mirror at an angle of 45°, and the optical axis of the laser tube is parallel to the optical axis of the receiving tube.

Further, the transmitting system further includes a transmitting objective lens, and the basic receiving system further includes a receiving objective lens, in which the center of the first reflector mirror, the center of the second reflector mirror, the center of the third reflector mirror, the central axis of the transmitting objective lens and the central axis of the receiving objective lens are on the same straight line.

Further, the transmitting objective lens and the receiving objective lens are convex lenses.

Further, the center of the reflective element is not on the straight line.

Compared with the prior art, the application has the following advantages:

1. The laser radar receiving system provided by the present application can reflect the laser beam projected by the target outside the light receiving blind area caused by the emitting channel into the receiving tube through the reflecting element outside the light receiving blind area caused by the emitting channel, so as to comprehensively collect the diffuse reflection light of the near target, improve the information collection rate of the near target, and further expand the near measurement range of the existing laser radar.

2. In addition, for the laser radar with window cover, the laser radar receiving system provided by the present application further sets the reflection element outside the stray light interference area caused by the window cover to avoid the interference of stray light diffusely reflected by the window cover, thus improving the measurement accuracy and further expanding the measurement range of the radar.

### BRIEF INTRODUCTION OF THE DRAWINGS

FIG. 1 is a schematic diagram of the optical path of the laser radar of the application.

### REFERENCE NUMBER

11—Window cover, 111—first area, 112—second area, 113—third area, 12—first reflector mirror, 121—first reflector mirror's reflecting surface, 131—side wall, 1311—outer side wall, 1312—inner side wall, 141—laser tube, 142—second reflector mirror, 143—transmitting objective lens, 151—third reflector mirror, 152—receiving tube, 153—receiving objective lens, 16—reflecting element.

### DETAILED DESCRIPTION OF THE PREFERRED EMBODIMENTS

The advantages of the present application will be explained in detail with reference to the drawing and preferred embodiments.

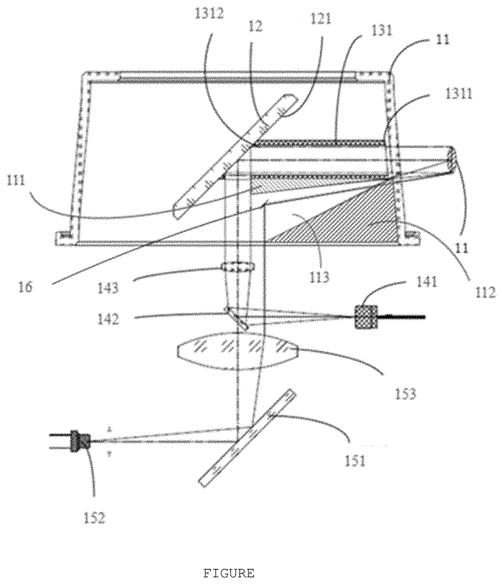

As shown in FIG. 1, the present application provides a laser radar receiving system, in which the laser radar includes a first reflector mirror 12, an emitting channel, an emission system and a basic receiving system. The laser beam emitted by the emission system is reflected by the first reflector mirror 12, and then reaches a target through the emitting channel. The laser beam reflected from the target passes through the emitting channel, and then is reflected by the first reflector mirror and finally received by the basic receiving system. The laser radar receiving system further includes a reflecting element 16. The space outside the emitting channel includes an area which the laser beam diffusely reflected from the target cannot reach due to the blocking of the emitting channel, i.e., a light receiving blind area, and the reflecting element 16 is disposed outside the light receiving blind area, and is used for reflecting the laser beam diffusely reflected from the target outside the light receiving blind area to the basic receiving system. Therefore, the laser beam projected by the target outside the light receiving blind area can be reflected into the receiving tube 152, so as to comprehensively collect the diffuse reflection light of the close-range target, improve the information collection rate of the short-range target, and further expand the short-range measurement range of the radar. For example, the existing laser radar will have different nearest measurement ranges according to the specific environmental requirements. In other words, there will be a near range measurement blind area. The application can further expand the near range measurement by adding the reflective element 16. For example, the shortest range of a laser radar in a specific use environment is 0.8 m, which means the target within 0.8 m of the laser radar cannot be measured. However, by adding the reflecting element 16, the laser radar receiving system of the present application can further extend the nearest measuring range from 0.8 m to 0.3 m, which means that the target within 0.3 m from the laser radar cannot be measured, thus further expanding the short measuring range of the laser radar. Preferably, the nearest range of the laser radar using the laser radar receiving system of the present application is 0.1 m. The laser radar receiving system can be applied to various laser radars, including but not limited to triangulation ranging laser radar, pulse ranging laser radar based on time flight, and phase ranging laser radar; or coaxial laser radar and non-coaxial laser radar; or mechanical laser radar or solid-state laser radar. Preferably, the reflective element 16 is a reflector mirror, in which the reflector mirror is circular, rectangular, triangular or in other shapes.

When a parallel laser beam hits the rough surface of the target, the surface will reflect the beam in all directions. Therefore, although the incident rays are parallel to each other, the normal directions of each point are inconsistent, resulting in irregular reflection of the reflected beam in different directions, which is called diffuse reflection. Moreover, the window cover 11 of the existing laser radar is provided with an emitting channel. Generally speaking, the emitting channel is an opaque hollow cylindrical structure, such as an opaque cylindrical structure or a square one. The emitting channel has a side wall 131, which is circular to form the cylindrical shape. The side wall 131 has an outer side wall 1311 and an inner side wall 1312, in which the outer side wall 1311 refers to the side wall near one end of the window cover 11, and the inner side wall 1312 refers to the side wall away from the window cover 11. As the light propagates linearly, when the distance between the target and the laser radar is short, and the received laser beam is diffusely reflected by the target, the laser beam reflected back into the window cover 11 cannot reach some areas outside the emitting channel due to the blocking of the opaque emitting channel, especially the blocking of the outer end side wall 1311. This means there is a light receiving blind area and it cannot be further reflected by the first reflector mirror 12 to the basic receiving system. Therefore, two-dimensional or three-dimensional information of near-range objects cannot be obtained. This is one of the reasons why the existing laser radar has a blind area for near-range detection. By adding the reflecting element 16, the radar receiving system of the present application can shorten the blind area of short-range detection, and further expand the short-range measurement range of laser radar.

According to an embodiment of the present application, the laser radar further includes a window cover 11, in which the first reflector mirror 12, the transmitting channel and the reflecting element 16 are arranged, and the transmitting system and the basic receiving system are arranged outside the window cover 11. The space outside the transmitting channel in the window cover 11 includes a first area 111, a second area 112 and a third area 113. The first area 111 is an area which the laser beam diffusely reflected from the target cannot reach due to the blocking of the emitting channel, the second area 112 is an area which the laser beam emitted from the emitting channel reflects back into the window cover 11 through the window cover 11, and the third area 113 is located between the first area 111 and the second area 112. That is, the third area 113 is a space other than the first area 111 and the second area 112 outside the emitting channel in the window cover 11. The reflecting element 16 is disposed in the third area 113 for reflecting the laser beam diffusely reflected from the target back into the third area 113 to the basic receiving system. It can not only avoid the blind area of short-distance detection, but also avoid the interference of stray light, so as to improve the measurement accuracy and further expand the measurement range.

The laser beam emitted by the emission system is reflected by the first reflector mirror 12, reaches the target through the emitting channel, and forms a spot on the target. In addition, when the laser radar has a window cover 11, the laser beam emitted by the laser radar will pass through the inner and outer walls of the window cover 11. As the inner and outer walls are not ideal smooth surfaces, the surfaces of the inner and outer walls of the window cover 11 will diffusely reflect the laser beam emitted by the laser radar, which means the stray light will be formed. Because of the blocking of the emitting channel in the window cover 11, specifically, the blocking of the outer end side wall 1311 of the emitting channel, and the linear propagation of light, the laser beam diffusely reflected from the inner and outer walls of the window cover 11 can only fill the second area 112 (i.e. the stray light interference area), and the basic receiving system cannot distinguish the effective echo signal reflected from the near effective target after receiving the stray light signal, thus resulting in the blind area of short distance measurement or lower measurement accuracy. The stray light will superimpose and interfere with the useful return light signal, thus affecting the measurement accuracy. If it is a long-distance return signal, the signal is weak, while the stray light signal always exists in equal quantity, which will cause greater interference to the long-distance return signal, and even cause the circuit to be unable to distinguish the long-distance signal, thus affecting the measurement range. In the present application, the reflective element 16 is added and disposed outside the second area 112, so that the stray light interference caused by the window cover 11 can be avoided. Preferably, the reflecting element 16 is disposed in the third area 113, that is, the third area 113 is an area outside the emitting channel, which is neither the first area 111 nor the second area 112, so that the laser beam of the present application can simultaneously avoid the light receiving blind area caused by the emitting channel and the stray light interference area caused by the window cover 11, thus comprehensively collecting the diffuse reflection light of the near-range target, improving the information collection rate of the near-range target, and further expanding the measurement range of the radar and improving the measurement accuracy.

The spatial size of the first area 111 is negatively correlated with the distance between the target and the laser radar. Specifically, the first area 111 in FIG. 1 is larger when the distance between the target and the laser radar is shorter, and vice versa. The spatial size of the second area 112 is positively related to the distance between the emitting channel and the window cover 11. The second area 112 is larger when the distance between the emitting channel and the window cover 11 is longer, and vice versa. However, for a specific laser radar, the distance between the emitting channel and the window cover is fixed, so the second area 112 is a fixed area. Therefore, only the actual size of the first area 111 changes with the distance between the target and the laser radar.

Preferably, the optical axis of the transmitting system and that of the basic receiving system are coaxial or non-coaxial. The optical axis of the emission system refers to the central axis of the laser beam emitted from the laser tube 141 between the laser tube 141 and the second reflector mirror 142. The optical axis of the basic receiving system refers to the central axis of the laser beam received by the receiving tube 152 between the third reflector mirror 151 and the receiving tube 152. Typically, the optical axis of the transmitting system and the optical axis of the basic receiving system are not coaxial, but the optical axes may be parallel or vertical.

When the optical axis of the transmitting system is parallel to that of the basic receiving system, for example, the transmitting system includes a laser tube 141 and a second reflector mirror 142 for emitting laser beams, the laser tube 141 is preferably a laser diode. The laser beam emitted by the laser tube 141 is reflected by the second reflector mirror 142 and the first reflector mirror 12 in turn, and then passes through the emitting channel to the target that is transmitted outside the window cover 11. Preferably, the laser radar is a mechanical laser radar, which further includes a motor, and the first reflector mirror 12 and the emitting channel are driven by the motor together. Preferably, the first reflector mirror 12 and the emitting channel can rotate in all directions. The basic receiving system includes a third reflector mirror 151 and a receiving tube 152. The laser beam diffusely reflected by the target passes through the transmitting channel, and then is reflected to the receiving tube 152 by the first reflector mirror 12 and the second reflector mirror 142 in turn. Preferably, the reflecting surface 121 of the first mirror and the reflecting surface of the reflecting element 16 are opposite to and parallel to the reflecting surface of the third reflector mirror 151. Preferably, the central axis of the emitting channel intersects the center of the first reflector mirror 12, the optical axis of the receiving tube 152 intersects the center of the third reflector mirror 151 at an angle of 45°, the optical axis of the laser tube 141 intersects the center of the second reflector mirror 142 at an angle of 45°, and the optical axis of the laser tube 141 is parallel to that of the receiving tube 152. Preferably, the transmitting system outside the window cover 11 further includes a transmitting objective lens 143 for collimating the diffused laser beams, and the basic receiving system further includes a receiving objective lens 153 for converging the parallel laser beams. Preferably, the transmitting objective lens 143 and the receiving objective lens 153 are convex lenses. Preferably, the convex lenses are lenticular lenses, plano-convex lenses, concave-convex (or positive meniscus) lenses, etc. The transmitting objective lens 143 and the receiving objective lens 153 are spherical mirrors or aspherical mirrors. Preferably, the center of the first reflector mirror 12, the center of the second reflector mirror 142, the center of the third reflector mirror 151, the central axis of the transmitting objective lens 143, and the central axis of the receiving objective lens 153 are on the same straight line, and the center of the reflecting element 16 is not on the straight line, as shown in FIG. 1.

According to the above embodiments of the present application, the principle of the optical path of the laser beam is that the laser beam emitted from the laser tube 141 is reflected by the second reflector mirror 142, collimated into a parallel beam by the emission objective lens 143, reflected by the first reflector mirror 12, passes through the emitting channel, passes through the window cover 11, and is finally projected onto the target to form a spot. Part of the laser beam from the emitting channel is reflected or diffusely reflected back into the window cover 11 by the window cover 11, and is projected into the second area 112 in the window cover 11, that is, the stray light interference area. The parallel laser beam projected on the target is reflected and diffusely reflected on the surface of the target, and part of the laser beam is reflected back to the emitting channel by the target. This part of the laser beam reflected back to the emitting channel is first reflected by the first reflector mirror 12, then passes through the receiving objective lens 153 and converges, is reflected by the third reflector mirror 151, and finally received by the receiving tube 152. Part of the laser beam is diffusely reflected by the target to the area outside the emitting channel, and the area outside the emitting channel that cannot be reached due to the blocking of the emitting channel is the first area 111. In order to diffuse the laser signal of the target outside the emitting channel to the laser tube 141, and avoid the stray light that will reduce the measurement accuracy, the laser radar receiving system of the present application adds the reflecting element 16, and the reflecting element 16 is located in the third area 113 between the first area 111 and the second area 112, so that it can simultaneously achieve the functions of further expanding the short-distance measurement range and avoiding the stray light interference to improve the measurement accuracy.

To sum up, the laser radar receiving system of the present application can achieve the technical effects of further expanding the short-distance measurement range and avoiding the stray light interference to improve the measurement accuracy by adding the reflecting element 16 and setting the reflecting element 16 in the area outside the short-distance receiving blind area and the stray light interference area (as shown in the third area 113 in FIG. 1).

The above specific embodiments have been described in detail, but they are only part of the examples, and the application is not limited to the embodiments. For those skilled in the art, any equivalent modifications and substitutions made to the present application are also within the scope of the present application. Therefore, all equivalent changes and modifications made without departing from the spirit and scope of the present application should be covered within the scope of the present application.

1. A laser radar receiving system comprising a laser radar and a reflecting element,
wherein said laser radar comprises a first reflector mirror, an emitting channel, an emission system and a basic receiving system,
wherein a laser beam emitted by the emission system is: reflected by said first reflector mirror and reaches a target through said emitting channel; is reflected from the target and passes through the emitting channel; and is reflected by the first reflector mirror and received by said basic receiving system,
wherein an area outside said emitting channel is unreachable by said laser beam reflected from the target, and
wherein the reflecting element is disposed outside said area and reflects said laser beam reflected from the target to said basic receiving system.

2. The laser radar receiving system according to claim 1, wherein:
said laser radar further comprises a window cover,
said first reflector mirror, said emitting channel and said reflecting element are arranged inside said window cover,
said emission system and said basic receiving system are arranged outside said window cover,
said area outside said emitting channel inside the window cover includes a first area, a second area and a third area,
said first area is an area that is unreachable by said laser beam reflected from the target, said second area is an area in which the laser beam emitted from said emitting channel is reflected back into said window cover, said third area is located between said first area and said second area, and said reflecting element is disposed in said third area and used for reflecting said laser beam diffusely reflected from the target back to said basic receiving system.

3. The laser radar receiving system according to claim 2, wherein a spatial size of said first area negatively correlates with a distance between the target and said laser radar.

4. The laser radar receiving system according to claim 1, wherein said reflecting element is a reflector mirror, and said emitting channel has an opaque hollow cylindrical structure.

5. The laser radar receiving system according to claim 1, wherein:
said emission system comprises a laser tube and a second reflector mirror, and said laser tube emits said laser beam, which is reflected by said second reflector mirror and said first reflector mirror in turn, and then passes through said emission channel to the target outside said window cover;
said basic receiving system comprises a third reflector mirror and a receiving tube, and said laser beam reflected by the target passes through said emitting channel, and then is reflected to said receiving tube by said first reflector mirror and said second reflector mirror in turn.

6. The laser radar receiving system according to claim 5, wherein a first reflecting surface of said first reflector mirror and a second reflecting surface of said reflecting element are opposite to and parallel to a third reflecting surface of said third reflector mirror.

7. The laser radar receiving system according to claim 6, wherein:
a central axis of said emission channel intersects with a center of said first reflector mirror,
an optical axis of said receiving tube intersects with a center of said third reflector mirror at an angle of 45°,
an optical axis of said laser tube intersects with a center of said second reflector mirror at an angle of 45°, and
the optical axis of said laser tube is parallel to the optical axis of said receiving tube.

8. The laser radar receiving system according to claim 7, wherein said emission system further comprises a transmitting objective lens, and said basic receiving system further comprises a receiving objective lens, and the center of said first reflector mirror, the center of said second reflector mirror, the center of said third reflector mirror, the central axis of said transmitting objective lens and the central axis of said receiving objective lens are arranged along a common straight line.

9. The laser radar receiving system according to claim 8, wherein said transmitting objective lens and said receiving objective lens are convex lenses.

10. The laser radar receiving system according to claim 8, wherein the center of said reflecting element is not on the common straight line.
